(19) United States
(12) Patent Application Publication
(10) Pub. No.: US 2008/0052245 A1
(43) Pub. Date: Feb. 28, 2008

(54) ADVANCED MULTI-FACTOR AUTHENTICATION METHODS

(76) Inventor: Richard Love, Encinitas, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/842,353

(22) Filed: Aug. 21, 2007

Related U.S. Application Data
(60) Provisional application No. 60/839,965, filed on Aug. 23, 2006.

(51) Int. Cl. H04L 9/32; G06Q 30/00; G06Q 40/00

(52) U.S. Cl. 705/76; 705/50; 726/9

(57) ABSTRACT

Methods, software, and systems for authenticating electronically accessible sites are described. In general, the development involves querying an identified user connected to an electronically accessible third party vendor site (e.g., a website) for a codebook identifier that corresponds to a codebook having a plurality of identification units, each of which includes a first identifier and a second identifier, and a keystone identifier; following receipt of the codebook identifier, querying the user with a variable image challenge comprised of the keystone and the first identifier for at least one identification unit in the codebook; and prompting the user to enter the second identifier for each identification unit displayed in the image challenge to form a one time passcode. Following entry of a passcode that corresponds to the image challenge, the authenticity of the user is confirmed to the vendor site.

### CROSS REFERENCE TO RELATED APPLICATIONS

This application claims priority to U.S. Provisional Application No. 60/839,965, titled “ADVANCED MULTI-FACTOR AUTHENTICATION METHODS,” filed Aug. 23, 2006, which is incorporated by reference in its entirety.

### BACKGROUND

1. Field

The development generally relates to the authentication of sources of electronic communication, and more particularly to authenticating a user and a vendor desiring to exchange information or conduct business via a network.

2. Background

Reliably authenticating one party to another (or one system to another) remains a key challenge in electronic communications. Authentication is particularly important when communicating over open, widely distributed public computer networks (e.g., the Internet) to access the World Wide Web. It is common practice for users (e.g., customers) to authenticate themselves to third party vendors (e.g., financial institutions, merchants, service providers, or governments) by providing a shared secret, such as a password, in order to access the vendor's website. In general, after a user has registered online with a particular vendor by providing the required registration information to complete the vendor's on-line registration form, the user's registration information is stored in a computer database system. The stored information can be rapidly accessed on an “as-needed” basis in connection with a user's online activities with that vendor. After registration, a user name/password authentication system is typically employed to confirm a user's identity during subsequent visits to the vendor's site.

Providing an appropriate username and password can authenticate a user to a vendor, but it does not authenticate the vendor (or the vendor's website) to the user. As a result, unscrupulous actors have devised a number of fraudulent schemes to obtain confidential, secret, or other sensitive information from users. One class of such schemes is commonly referred to as “phishing,” a reference to providing an attractive but fraudulent user interface as “bait” in an attempt to lure a user to disclose sensitive information. Typical “phishing” involves a website masquerading as an authentic vendor or business with whom a user wishes to communicate or otherwise share sensitive information. Examples of such information include, but are not limited too, passwords, credit card details (including account numbers, expiration dates, security codes, names as they appear on cards, etc.), or social security numbers. Phishing has become prevalent as Internet commerce has increased. Between May 2004 and May 2005, it is estimated that approximately 1.2 million computer users in the United States suffered phishing-related losses.

A number of approaches have been developed to combat phishing schemes, including user education, legal action, and technical responses. From a technical perspective, anti-phishing approaches include browsers that notify users of suspected phishing sites, spam filters, and collecting lists of malicious websites and blocking user access to such sites. In addition, some vendors have added verification tools that allow users visiting the vendor's public site to see a secret image, such as a pass mark, that the user selects in advance. If the image does not appear to the user upon visiting the vendor's website, and then the website is not authentic. Such tools can be used alone or in conjunction with challenge questions, e.g., questions that probe for information that should be known only to the user and the bank.

As the preceding paragraph suggests, the most successful anti-phishing approaches utilize methods that require third party authentication to users. User authentication processes can also be used to prevent access by fraudulent users. Such processes typically require a user to employ a particular computer and/or to possess a physical item, such as a security token, for the authentication routine to be successfully executed. However, security tokens can be expensive, must be physically delivered, and if lost may take several days to replace. Other solutions may involve the use of a vendor issued and printed serialized code card that contains several rows and columns. At the intersection of a row and column, a particular alphanumeric character is present. When a user attempts to login to the card issuer's website, the user may be queried not only for his/her username and password, but also the identity of a particular alphanumeric character at a row/column position on the code card.

In today's world of ubiquitous electronic transactions, restricting users to particular computers and/or requiring them to possess a particular security token to authenticate third party web sites hinders the deployment and adoption of many services designed for simple, safe, yet secure forms of electronic communication. Compatibility of the security token to every communication system a user could use to access a vendor can be an issue. Moreover, items such as physical security tokens are expensive. Misplaced or stolen vendor-issued code cards and security tokens may take days to replace, rendering them less than ideal solutions for use in conjunction with multi-factor authentication processes.

The development addresses these and other shortcomings of conventional approaches. To address these problems, methods and systems are described that enable users to authenticate sources with which they wish to communicate, and provide user authentication using a variety of computing devices having a network connection with the source.

### SUMMARY OF CERTAIN EMBODIMENTS

The system, method, and devices of the invention each have several aspects, no single one of which is solely responsible for its desirable attributes. Without limiting the scope of this disclosure, its more prominent features will now be discussed briefly. After considering this discussion, and particularly after reading the section entitled “Detailed Description of Certain Embodiments” one will understand how the features of these embodiments provide advantages over other authentication methods and systems.

In one embodiment a method of authenticating an electronic communication between a client device operated by a user and a vendor computer system includes receiving a user identifier from a client device; receiving a codebook identifier from said client device that identifies a codebook, said codebook comprising a plurality of identification units, each identification unit having a first identifier and a corresponding second identifier, and a keystone identifier; validating the codebook identifier by determining whether said codebook identifier is associated with said user identifier; upon successful validation of the codebook identifier, providing an image challenge comprising said keystone identifier (typically located in a predetermined position in the image challenge) and at least one first identifier arranged in a list or sequential order; receiving a passcode responsive to said image challenge from the client device; and authenticating said passcode by determining if said passcode comprises a second identifier corresponding to each first identifier in said image challenge. Authenticating can further include determining whether each second identifier in said passcode is in the same sequential order as each corresponding first identifier in said image challenge. The first and second identifiers comprise symbols; typically the first identifier comprises an image and the second identifier comprises an alphanumeric character. The image challenge typically includes a plurality of first identifiers. Also, the position of the keystone identifier in the image challenge can be predetermined and known only to the user and the authentication system. Providing the image challenge can include selecting at least one identification unit from the plurality of identification units, and assembling the first identifier of each selected identification unit and the keystone identifier into the image challenge. The method can further include determining whether the user identifier matches a known user identifier; and initiating a secure communication channel between the client device and said vendor if the user identifier matches a known user identifier. Initiating a secure communication channel can include providing vendor information to the client device to authenticate the vendor. The vendor information can comprise a digital certificate identifying said vendor. The method can also include receiving user identity information from said client device, and determining whether to allow access to said vendor based on said identity information and said passcode. The user identity information can be selected from the group consisting of a password, biometric data, and/or bibliographic information.

In another embodiment, a method of authenticating an electronic communication with a user who has established a communication channel with an electronically accessible vendor includes providing a first field displayable on a user interface, said first field configured to receive a codebook identifier, said codebook identifier being associated with a codebook comprising a plurality of identification units, each identification unit having a first identifier and a corresponding second identifier, and a keystone identifier; providing an image challenge displayable on said user interface, said image challenge comprising a keystone identifier and at least one first identifier of an identification unit from a codebook associated with said codebook identifier; and providing a second field displayable on said user interface, said second field configured to receive a passcode responsive to said image challenge, the passcode comprising at least one second identifier, each said at least one second identifier corresponding to one first identifier in said image challenge; and each second identifier in the passcode being in the same sequential order as each corresponding first identifier in the image challenge.

In another embodiment, a method of authenticating communication between an electronically accessible vendor site and a user includes prompting for a codebook identifier from a user, said codebook identifier associated with a codebook comprising a plurality of independent identification units, wherein each identification unit comprises a first identifier and a second identifier, and a keystone identifier; following receipt of said codebook identifier, prompting for a passcode in response to an image challenge displayed to said user, said image challenge comprising said keystone identifier and a first identifier for at least one identification unit in said codebook; and upon receipt of said passcode, authenticating the user by determining if said passcode comprises a corresponding second identifier of an identification unit for each first identifier of said identification unit displayed in said image challenge. Authenticating can further comprise determining if said corresponding second identifier in said passcode is in the same sequential order as said each first identifier in said image challenge. The method can further include prompting for a user identifier from the user, and authenticating the user using the user identifier and the codebook identifier.

In another embodiment, a method of authenticating electronic communication between a user operated client device and a vendor includes receiving a codebook identifier from said client device that identifies a codebook, said codebook comprising a plurality of identification units, each identification unit having a first identifier and a corresponding second identifier, and a keystone identifier; providing an image challenge based on said codebook identifier, said image challenge comprising said keystone identifier and at least two first identifiers in a sequential order, said keystone identifier being located in a predetermined position of said sequential order, and said at least two first identifiers being located in a random order in said sequential order; receiving a passcode responsive to said image challenge from said client device; and authenticating said passcode by determining if said passcode comprises a second identifier corresponding to each first identifier in the image challenge.

Another embodiment includes a machine readable medium comprising instructions for authenticating an electronic communication between a user operated client device and a vendor computer system that upon execution cause a machine to receive a codebook identifier from said client device that identifies a codebook, said codebook comprising a plurality of identification units, each identification unit having a first identifier and a corresponding second identifier; and a keystone identifier; provide an image challenge comprising said keystone identifier and at least two first identifiers in a sequential order, said keystone identifier being located in a predetermined position of said sequential order, and said at least two first identifiers being located in a random order in said sequential order; receive a passcode responsive to said image challenge from the client device; and authenticate said passcode by determining if said passcode comprises a second identifier corresponding to each first identifier in the image challenge, each second identifier in the passcode being in the same sequential order as each corresponding first identifier in the image challenge.

In another embodiment, a method of authenticating an electronic communication between a client device operated by a user and a vendor computer system includes means for receiving a codebook identifier from said client device that identifies a codebook, said codebook comprising a plurality of identification units, each identification unit having a first identifier and a corresponding second identifier; and a keystone identifier; means for providing an image challenge comprising said keystone identifier and at least two first identifiers in a sequential order, said keystone identifier being located in a predetermined position of said sequential order, and said at least two first identifiers being located in a random order in said sequential order; means for receiving a passcode responsive to said image challenge from the client device; and means for authenticating said passcode by determining if said passcode comprises a second identifier corresponding to each first identifier in the image challenge, each second identifier in the passcode being in the same sequential order as each corresponding first identifier in the image challenge.

In another embodiment, a system for authenticating an electronic communication includes a user identifier module configured to receive a user identifier and determine if said user identifier is associated with a known user; a codebook identifier module configured to receive a codebook identifier and validate said codebook identifier by determining whether said codebook identifier is associated with said user identifier and associated with a codebook, said codebook comprising a plurality of identification units, each identification unit having a first identifier and a corresponding second identifier, and a keystone identifier; an image challenge module configured to provide an image challenge comprising said keystone identifier and at least one first identifier arranged in a sequential order upon successful validation of the codebook identifier; a passcode comparison module configured to authenticate said passcode by determining whether said passcode comprises a corresponding second identifier of an identification unit for each first identifier of said identification unit in said image challenge, and whether said corresponding second identifier in said passcode is in the same sequential order as each first identifier in said image challenge.

### BRIEF DESCRIPTION OF THE DRAWINGS

FIG. 1A is a block diagram illustrating a system for authenticating communications between a user and a vendor.

FIG. 1B is a block diagram illustrating one example of a multi-factor authentication system that authenticates a user to a vendor and authenticates the vendor to the user.

FIG. 2 is a block diagram illustrating one example of modules that can be included in an authentication system.

FIG. 3 illustrates an example of a codebook.

FIG. 4 illustrates an example of an image challenge provided by an authentication system.

FIG. 5 illustrates an example of using a codebook to decode a image challenge and produce a passcode.

FIG. 6 is a diagram illustrating another example of a codebook.

FIG. 7 is a flow diagram that illustrates certain steps of a method for authenticating a vendor site to a user and the user to the vendor site.

FIG. 8 is a diagram illustrating an example of an field used to enter a user identifier for authentication.

FIG. 9 is a diagram illustrating an example of an field that is used to enter a codebook identifier for authentication.

FIG. 10 is a diagram illustrating an example of fields for entering authentication information.

FIG. 11 is a flowchart illustrating an example of a process of authenticating electronic communication.

FIG. 12 is a flowchart illustrating an another example of a process of authenticating electronic communication.

FIG. 13 is a flowchart illustrating an example of a process of authenticating electronic communication between a vendor site and a user.

FIG. 14 is a flowchart illustrating an example of a process of authenticating electronic communication between a user operated client device and a vendor.

### DETAILED DESCRIPTION OF CERTAIN EMBODIMENTS

The following detailed description is directed to certain specific embodiments of the development. In this description, reference is made to the drawings wherein like parts are designated with like numerals throughout.

Reference in this specification to “one embodiment,” “an embodiment,” or “in some embodiments” means that a particular feature, structure, or characteristic described in connection with the embodiment is included in at least one embodiment of the invention. The appearances of the phrases “one embodiment,” “an embodiment,” or “in some embodiments” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

The number of applications requiring authentication of communicating parties has increased with the advent of widely accessible computer networks. The need for authenticating the source of a communication has also increased because of widespread criminal schemes that attempt to fraudulently obtain user identity-related information. The information typically sought includes bank and credit card account numbers, Social Security numbers, passwords, PINs, and other information related to a user's identity, finances, business, or personal information. The authentication development described herein can be implemented to drastically reduce online identity theft and prevent compromising personal finances and credit. The authentication development can also combat “phishing,” “man-in-the-middle” attacks, online account hijacking, and other fraudulent schemes by ensuring a user is communicating an authenticate source.

Methods and systems for authenticating third party sites and users during electronic communication are described herein. Examples of third party sites include, but are not limited to, websites, remote business network connections, and automatic teller machines (“ATM”). Such methods and systems can include a so-called “one-time password” authentication technique using images, where after the third party site is authenticated to a user, the user presents authentication information that is different each time the user attempts to access the site.

In some authentication embodiments, a user who wishes to login to the website of a vendor receives unique coded material from the vendor (or an authentication system used by the vendor) prior to the login attempt. The coded material contains information showing an association between at least two pieces of information that are known to the authentication system. For example, the coded material can include a unique “codebook” generated for a particular user. The codebook can contain a plurality of “identification units.” Each identification unit can contain a plurality of identifiers which can be distinguished by a user. In typical embodiments, each identification unit comprises two identifiers, e.g., a “first identifier” and a “second identifier.” Typically the first identifiers and the second identifiers are distinct. The first identifier and the second identifier are referred to as “corresponding” if they identify the same identification unit. The first and second identifiers are symbols that can be distinguished by the user. Such symbols include, for example, images, alphanumeric characters, video, sound, and color schemes. Typically, the first identifier is an image (e.g., a photograph, generated picture, video or any other rendered visible object) and the second identifier is an alphanumeric character (e.g., a number or letter) found on a keyboard or keypad of a computing device. The codebook also includes a “keystone identifier” (or “keystone image”) which can also be a symbol, and typically is an image.

When a user desires to access a vendor website, the user can first provide user identification information (a “user identifier”). User identification information can include a pre-assigned username and/or a codebook identifier (e.g., a codebook registration number). The user identifier can be provided in various ways. In one example, the user enters the identification information into a user interface which can prompt the user for such information. In another example, a computer token (e.g., a “cookie”) can be stored on a computer that was previously used by the user to login to the vendor site, and the computer token can provide the user identifier. The authentication system validates the user identifier as a known user. If the user is valid, the authentication system also uses the user identifier to access authentication information specific to the user. The authentication system then provides an “image challenge” which can be displayed on the computer or device being used by the user to access the site. The image challenge can comprise a randomly generated ordered group or sequence of two or more symbols. Typically, the keystone identifier is displayed in a particular position in the image challenge. The remaining symbols each match one of the first identifiers of an identification unit in the codebook. The user can determine whether the vendor site is genuine by verifying that the user's keystone identifier is present in the chain of symbols and located in a predetermined position known only to the user and the authentication system. The user can also determine if the vendor site is authentic by determining if each first identifier is associated with an identification unit in the user's codebook.

In response to the image challenge, the user can provide an authentication passcode which is communicated to the vendor. The passcode can be a string of alphanumeric characters input by the user and determined using the codebook. In some embodiments the passcode can also comprise a password or other information associated with the user and known only by the user and the authentication system. To determine the responsive passcode, the user identifies a identification unit in the codebook for each first identifier in the image challenge. Then the user enters a passcode comprising the corresponding second identifier of each identified identification unit (e.g., the second identifier corresponding to the first identifier) in the same order as the first identifiers appear in the image challenge. Other required information (e.g., a password) can also be entered by the user. The keystone identifier is typically ignored. The authentication system can validate the passcode with information associated with the codebook identifier. If the passcode is valid, the authentication system deems the user to be authentic and allows the user to access the vendor's website. Using this development, the user can determine if the website is valid before entering sensitive personal information, and the vendor can determine if the user is authorized to enter the website before allowing access to sensitive data.

Before further describing certain embodiments of the invention, several terms used herein will be discussed. In the context of the embodiments described herein, generally “authentication” refers to establishing or confirming something or someone, e.g., a user or a third party website, as authentic. In particular, “source authentication” refers to establishing that the source is who or what the source purports to be. In other words, verifying or authenticating the source's identity. In reference to computer or electronic communication, “authentication” refers to a process that attempts to authenticate a communication to verify the identity of the sender of the communication. Such communications include, for example, a request for user login information, and with respect to third party websites, providing a webpage or a field to a user interface that includes requests, prompts, and/or queries for user login information and user authentication information. Such communications can also include, for example, email, financial or bank service transactions (e.g., bank automatic teller machines (ATMs)), and communications conducted over a cell phone, computer network, digital television network, and a satellite network.

Authentication protocols for authenticating a third party site for electronic communication with a user, for example, via a website or a dedicated computer, can depend upon one or more authentication factors. A “factor” useful for authentication refers to an element required for successful execution of the particular authentication routine. Such factors include those that are knowledge-based, as well as those that are physical or tangible.

A “biometric” factor refers to a physical characteristic that is used for authentication purposes. Generally, a biometric factor can only be changed by physically altering the physical characteristic. Providing a biometric factor typically requires a measurement or analysis of the factor by the authentication system or by an input device which “reads in” the biometric factor and provides information to the authentication system. Some examples include fingerprints, eye retinas and irises, facial patterns, and hand measurements. A biometric factor can also refer to a behavioral characteristic for authentication purposes. Some examples of behavioral characteristics include signature and voice pattern.

Authentication factors are generally classified into three types. One type is something a user “is.” Examples of something a user “is” include, but are not limited to, a fingerprint or retinal pattern, nucleic acid sequence, voice pattern, signature recognition, unique bio-electric signals produced by the living body, or another biometric identifier. Another type is something a user “has” or possesses. Examples include, but are not limited to, an ID card, a security token (including those that require connection, such as a USB-based security token, a network device, as well as those that are capable of operating free from a physical connection to a network device), a software token, a cell phone, and a vendor-issued code card or book that is provided to the user. The third type is something a user “knows.” Examples of something a user “knows” include, but are not limited to, a password, a pass phrase, a personal identification number (PIN), a “pass mark” (e.g., an image) that the user has previously selected and made known to the vendor for security purposes, or answers to questions regarding user bibliographic information (e.g., mother's maiden name, birthplace, favorite sports team, that etc.) or other user known information that the user previously selected and made known to the vendor for security purposes.

For enhanced security, a combination of authentication factors can be used. Herein, a “two-factor authentication” or “T-FA” refers to an authentication protocol that requires two independent ways to establish identity. Traditional authentication techniques requires only one factor (e.g., a password). Using more than one factor is typically referred to as “strong authentication”, whereas using just one authentication factor is considered “weak authentication.”

Typical implementations of two-factor authentication use “something you know” (e.g., a password, pass mark, or pass phrase) as one of the two factors, and either “something you have” or “something you are” as the other factor. A common example of T-FA is a bank card (credit card, debit card, smart card, etc.). The card serves as the physical factor (e.g., something one “has”) in conjunction with the user's PIN, which is data (e.g., something the user “knows”) that corresponds with the particular bank card. Some T-FA and other forms of “strong” authentication do not require a physical factor, such as card, dongle, or key fob. Indeed, the multiple factors can be of the “something you know” and/or “something you are” variety, particularly in the context of online authentication.

Multi-factor authentication (M-FA″) systems and methods can be used to provide higher levels of authentication than T-FA systems. M-FA systems can be advantageously used for vendor website access. Some other examples of M-FA implementations include a company wishing to grant access to the company website to their employees, a health care provider wishing to grant website access to its customers, a legal provider wishing to provide website access to its clients, a government or military agency providing strictly regulated access to sensitive and/or classified information, and an airport facility providing access to its employees or customers. Other applications of M-FA include military contracting, telephone service, cable television, importing, and journalism.

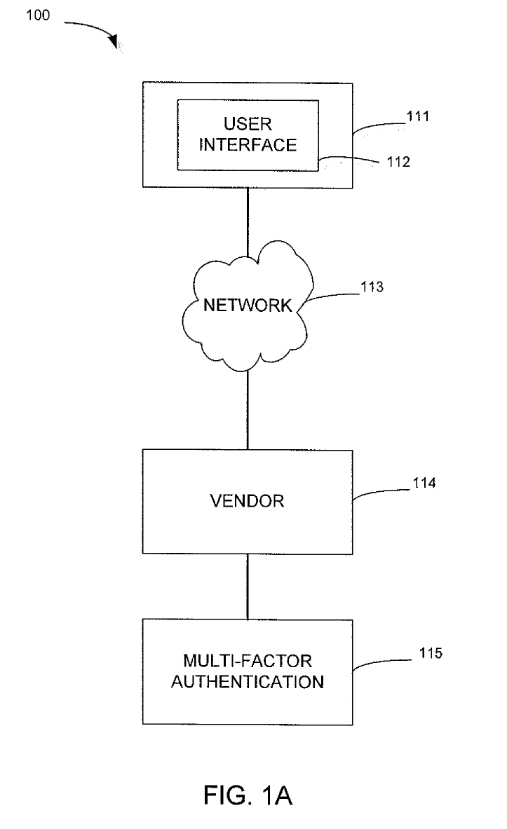

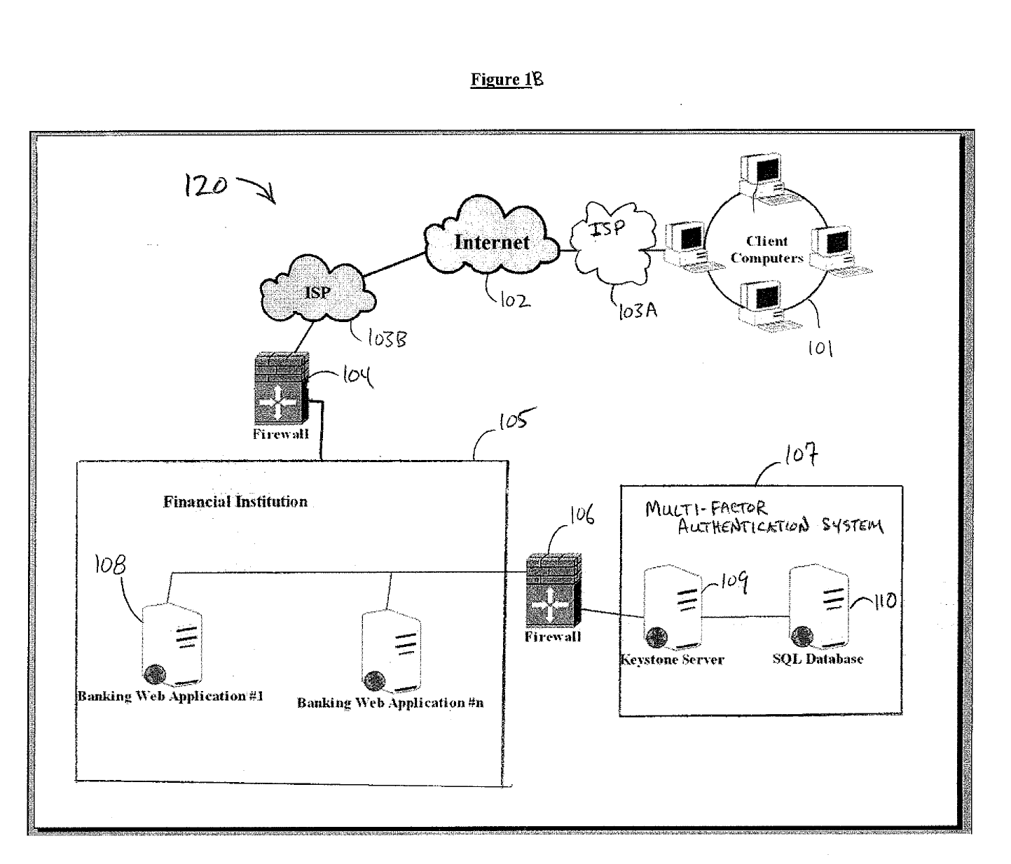

M-FA uses two or more authentication factors. Some M-FA embodiments are described in reference to FIGS. 1-14. Such embodiments can be implemented in a vendor's computer system or in a computer system in communication with a vendor's computer system. In some embodiments, the software (and/or hardware) for implementing M-FA embodiments can reside in whole or in part on a system supporting an online environment and can be accessed from any computer connected to the network. If desired, system access can be limited to selected computers, for example, to the computers residing within a corporation's computer network. In some M-FA embodiments, one of the authentication factors is something the user “knows” and the other factor is a token (e.g., a codebook) that the user can access and/or replace in electronic or physical form immediately, when needed. For example, a current or existing codebook, or a newly generated codebook, may be electronically downloaded at the user's request to a computer, cell phone, or other digital device, and printed, if desired.

FIG. 1A is a block diagram illustrating an example of a system 100 for authenticating electronic communication. The system 100 can be used to authenticate a vendor 114 (e.g., the vendor's website) to a user, and authenticate the user to the vendor 114, before the communicating parties provide sensitive information or transact business. The user and the vendor are authenticated by authenticating certain content of their communications. The system 100 includes a user interface 112 provided on a display of a computing device 111. The user interface 112 can be configured to provide one or more input fields for user provided information. Typically these fields are presented as a login screen, or multiple login screens (e.g., on a page of a vendor's website). The user interface 112 can also provide information to the user and prompt the user to provide certain information. The user interface 112 can be configured to accept user input that can include, for example, a user identifier (e.g., a username or other user identification information) codebook identifier, a passcode, a password, an answer to a security question, and/or other information associated with a particular user. The computing device 111 can include, but is not limited to, a computer or a terminal, a series of connected computers, a server, a mobile computing device (e.g., a PDA, laptop computer, handheld computer) a mobile communication device (e.g., a cell phone), or an ATM machine or another financial transaction system.

A network 113 in the system 100 communicates information between the user interface 112/computing device 111 and a computer system of a vendor 114. For example, the network 113 communicates information input into the user interface 112 to the vendor 114. The network 113 can be a (wired of wireless) wide area network, the Internet, or another network, or a plurality of interconnected networks, capable of communicating information from the user interface 112 to the vendor 114.

The system 100 also includes a multi-factor authentication (“M-FA”) system 115 which is configured to communicate with the vendor 114 over a wired or wireless network connection. The vendor 114 can interact with the M-FA system 115 in several ways. In one example, user login procedures requiring authentication between the vendor 114 and the computer device 111 can be redirected to the M-FA system 115 for performing authentication; when complete, the M-FA 115 can provide the vendor 114 an authentication status (e.g., success/error status). In another example, the vendor 114 can communicate authentication information to the M-FA system 115 in a step-by-step process, retrieve authenticating information (e.g., an image challenge) from the M-FA system 115, and provide the authentication information to the user interface 112.

In some embodiments, the M-FA system 115 is a standalone system separate from the vendor 114. In some embodiments the M-FA system 115 is partially or wholly co-located with the computer system of the vendor 114. The hardware and/or software comprising the M-FA system 115 can be incorporated into a computer system of the vendor 114. For example, the M-FA system 115 can be embodied as one or more software modules that execute on one or more processors of a vendor 114 computer system. In some embodiments, the M-FA system 115 resides at a different location than the vendor 114.

The M-FA system 115 can work in association with the vendor computer system to authenticate information from users attempting to access the vendor 114, and provide authentication related information to a user via the user interface 112. In particular, the M-FA system 115, described in more detail hereinbelow, can authenticate certain information sent from the computing device 111, for example, information relating to user source authentication (which may include a username, password, and/or a codebook identifier). The M-FA system 115 can provide authentication information to the computing device 111 for display on the user interface 112, including fields for entering user information The M-FA system 115 can also prompt the user to input required information and query the user for a response to certain displayed fields or information by displaying information and/or prompts on the user interface 112.

FIG. 1B is a block diagram illustrating one example of a system 120 that includes a multi-factor authentication system 107. In this example, the vendor is a financial institution 105, e.g., a bank, credit union, stock broker or other business that conducts financial transactions. The M-FA system 107 is configured to authenticate a user who wants to access the financial institution 105, and also to authenticates a website of the financial institution 105 to the user. The user can be a customer, prospective customer, client, an employee, or anyone who desires access to restricted or regulated information of the financial institution 105. For example, similar authentication processes can be used for employees remotely accessing their companies internal information.

The system 120 includes a client computer 101 configured to access a website of the financial institution 105 via the Internet 102. Internet Service Provider (“ISP”) 103A provides the client computer 101 access to the Internet 102. Similarly, ISP 103B provides the financial institution 105 connectivity to the Internet 102. The client computer 101 is configured to access the Internet 102 using one of the many suitable web browsers e.g., Microsoft's Internet Explorer. The client computer 101 can be a variety of electronic devices configured to communicate over the Internet 102, for example, a personal computer, a laptop computer or a computer system, a mobile telephone, a personal data assistants (PDA), a hand-held computer or another mobile computing device. The client computer 101 can have a security token loaded on the computer for identification, but in some embodiments it does not. However, in some embodiments where access to the financial institution 105 via a particular computer is mandated for heightened security requirements, a software token can be required on the client computer 101 to authenticate the user.

System 120 includes a firewall 104 between the financial institution 105 and ISP 103B, and a second firewall 106 between the financial institution 105 and the M-FA system 107. Generally, a firewall is a hardware and/or software device which is configured to permit, deny, or proxy data through a computer network which has different levels of security. In this embodiment, the firewalls 104 and 106 add a level of control to data communicated to and from the financial institution 105. For example, the firewall 104 prevents certain unauthorized access to the financial institution 105 from the Internet 102.

The financial institution 105 contains one or more banking web applications 108 which can communicate with users outside of the financial institution 105 through the ISP 103B and the Internet 102. Typically, the banking web application 108 can be accessed by a user through a website which is controlled by the financial institution 105. Such a website may be hosted by the financial institution 105 directly (e.g., on its own computer system) or indirectly (e.g., on the ISP 103B or on another computer system in communication with the banking web application 108). When a user wishes to conduct business with the financial institution 105, the user can direct a browser on the client computer 101 to the website associated with the banking web application 108. If mere public information is sought, such information may be accessed on the website without user authentication. In some embodiments the banking web application 108 is accessible through a specific secure connection via the Internet 102 rather than through a login option available from a website. To access sensitive information and conduct financial transactions, the user must first initiate a login procedure that uses M-FA to authenticate both the user and the financial institution 105.

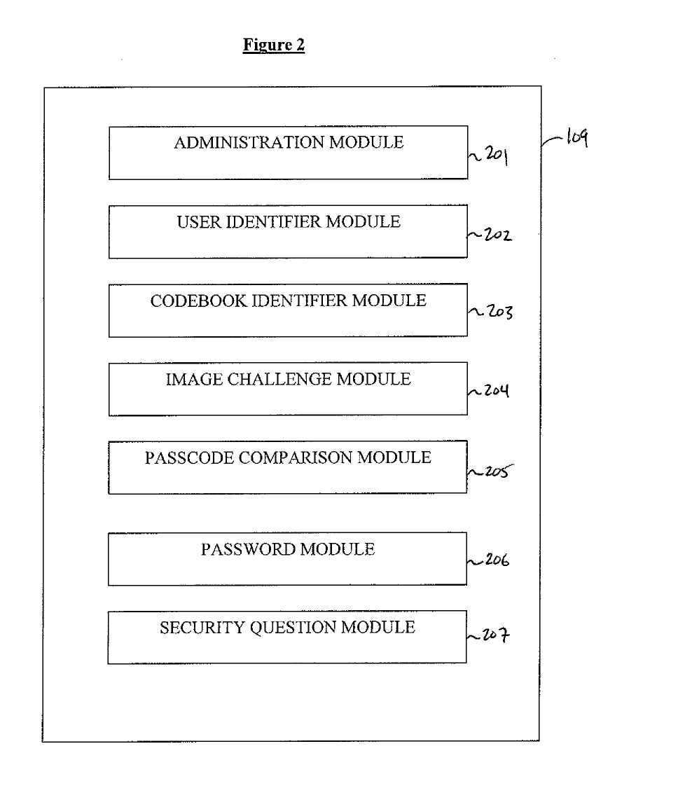

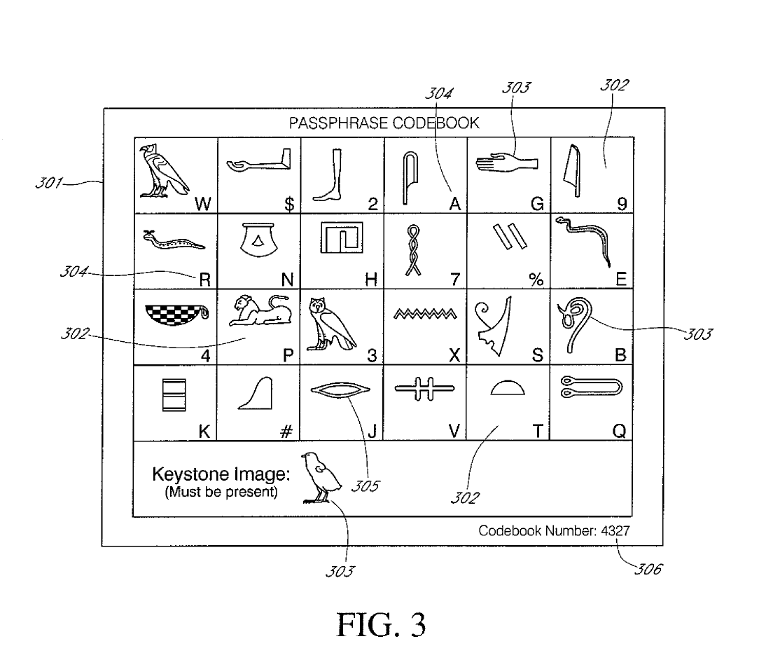

The M-FA system 107 includes a server which is referred to herein as a Keystone Server 109 to identify its ability to incorporate M-FA techniques described herein, including, for example, using a keystone identifier for authentication in information provided to the user. The M-FA system 107 also includes an electronic storage device 110 that stores a database containing information used to authenticate users. Examples of modules that can be included in the Keystone Server 109 are described in more detail in reference to FIG. 2. When the banking web application 108 is accessed by a user desiring to access sensitive information, the M-FA system 107 is used to authenticate the user and the vendor site. An example of a M-FA process that can be used by the M-FA system 107 is described hereinafter in reference to FIGS. 3-10. Once the financial institution 105 has been authenticated to a user, and the user has been authenticated to the financial institution, information stored in the storage device 110 can be accessed by the user and transactions can be made, if desired. In this example, an SQL database stores the authentication data used by the Keystone Server 109 to authenticate users. One of skill in the art will appreciate that any suitable database can also be used, or the information can be organized and stored in other suitable data formats and schemes.

The Keystone Server 109 may be configured with one or more modules that are used to authenticate the user and authenticate the vendor site. Authentication operations performed by the M-FA system 107 are further described below in reference to FIGS. 2-10. An example of an embodiment of the Keystone Server 109 modules are illustrated in FIG. 2. In some embodiments, the Keystone Server 109 operates as a standalone application that receives authentication information from the financial institution 105 (e.g., from HTTP POSTS or Web Services interfaces) and performs an authentication function requested by the financial institution 105 (e.g., the banking web application 108). The banking web application 108 can pass information and control to the Keystone Server 109 by HTTP POSTS having parameters that are mapped from calling application variable names to Keystone Server 109 names in configuration files. Parameters can include, but are not limited to, Username, SessionID, Action to be performed, return SuccessURL, and return ErrorURL. Actions of the Keystone Server 109 can include, but are not limited to, Authenticate User, Modify User Parameters, Create Codebook, Reset Codebook, recover from Lost Codebook, and recover from Lost Password. In other embodiments, once a user initiates an access or login request, the banking web application 108 turns control of the authentication procedure to the M-FA system 107 and the Keystone Server 109 performs the authentication. Once authentication is completed, the M-FA system 107 gives control back to the banking web application 105. Typically the Keystone Server 109 easily integrates with existing web applications that have the ability to add HTML code to existing web pages. In some embodiments, the Keystone Server 109 can be configured to block authentication or access from unknown servers and only grant authentication or access to known IP addresses and domains. The Keystone server 109 is configured with logic to ensure that the user receives a randomly generated image challenge, with a high probability of being different from any previously generated image challenge, each time a user launches a browser.

The Keystone server 109 can be configured to “remember” the user's login status across multiple websites that are associated with the same vendor. For example, if the bank has multiple websites, a user can login to one of the bank's websites, and then access the bank's other websites without being subjected to additional login and/or authentication procedures. In some embodiments, the multiple websites may have at least some additional authentication requirements. In such embodiments, the user can provide other authentication information (e.g., another passcode or password) when attempting to access the other vendor website.

FIG. 2 is a block diagram illustrating an example embodiment of a Keystone Server 109 and modules 201-207 that can be included in the Keystone Server 109. Such modules may be implemented in software, hardware, firmware, or combinations thereof. While referred to here as separate modules, it is appreciated that the functionality described for these modules can be implemented differently. For example, the modules can be combined into fewer modules or implemented as more (or different) modules. The modules can be software executed by one processor or several processors; if executed by several processors, such processors can be implemented in one computer or multiple computers

As illustrated in FIG. 2, the Keystone Server 109 includes an Administration Module 201 configured to facilitate configuration and administrative tasks associated with the operation of the Keystone Server 109. The Administration Module 201 can be configured to be accessed through an HTTP web interface, or through a more direct connection such as a dedicated administrator computer or interface. Administration Module 201 can be configured to modify, add, or delete operational parameters, and provide operational status. In some embodiments, only a small group of trusted operators have login access to the Administration Module 201, and it can only be accessible from internally networked computers. In some embodiments, some or all modifications to the settings of the Administration Module 201 will require multiple trusted operators to complete.

The Keystone Server 109 also contains a User Identifier Module 202. When a user wishes to access sensitive information (e.g., contained in the SQL Database 110), the banking web application 108 can prompt the user for a user identifier (e.g., a username or some other indicia that identifies the user). One or more indicia identifying the user can be required. A user identifier can be a string of one or more alphanumeric characters that are set by the financial institution or chosen by the user. In some embodiments, the user identifying indicia includes a user identifier and/or an “answer” to a user specific security question. When the user provides the user identifier to the banking web application 108, the User Identifier Module 202 can compare the user identifier to a database of known user identifiers to determine its authenticity.

The Keystone server 109 also contains a Codebook Identifier Module 203 that is configured to process a codebook identifier provided to the Keystone server 109. The Codebook Identifier Module 203 is configured to determine if the user is attempting to use a valid codebook, e.g., the most recently generated codebook that is associated with the user. The user typically enters the codebook identifier into a user interface, typically as a result of a prompt or a codebook identifier field presented on the user interface. In some embodiments, a software token residing on the user's computer can provide the codebook identifier. The Codebook Identifier Module 203 receives the codebook identifier, determines if the codebook identifier is associated with the user identifier (or other user identifying indicia), and determines if the codebook identifier is valid. If the codebook identifier matches a current codebook identifier in the database and the codebook identifier is associated with the user identifier, the user and codebook are deemed valid and the authentication process continues. If the codebook is not associated with the user identifier or the codebook identifier is incorrect, the Codebook Identifier Module 203 can provide appropriate information to inform the user of the authentication error. The user can again be prompted to provide a valid codebook identifier and/or a valid user identifier or user specific security answer to a security question.

The Keystone server 109 also contains an Image Challenge Module 204 that uses the codebook identifier provided by the user, and the codebook information to which it refers, to provide a certain level of authentication before allowing a user access to additional information or actions on the banking web application 108. The Image Challenge Module 204 uses the codebook identifier to identify information contained in the user's codebook including identification units (including the first and second identifiers) and a keystone identifier. Typically, the Image Challenge Module 204 selects a plurality of the identification units that are in the user's codebook and generates an image challenge by determining a sequential list that comprises each first identifier of the selected identification units and the keystone identifier. The sequence of the first identifiers in the image challenge can be random. The position of the keystone identifier in the image challenge can also be random. However, typically the keystone identifier is located at a predetermined position in the image challenge that is known only to the user and the authentication system.

The Image Challenge Module 204 selects at least one of the identification units for generating the image challenge. Typically two, three, four or five identification units are used, but more can be used, if desired. Smaller, less secure applications are also contemplated where only one identification unit is used to generate the image challenge, either with or without a keystone identifier. Once the Image Challenge Module 204 generates the image challenge, the image challenge is communicated to the user and displayed on the user interface. The user can be prompted to respond to the image challenge, by providing instructions to the user, or by providing a field for the user to enter a response. Typically the Image Challenge Module 204 randomly generates a new image challenge every time a user attempts secure access to the vendor's site (e.g., banking web application 108, FIG. 1B). In some embodiments requiring a lower level of security (e.g., some embodiments of an email application) the Image Challenge Module 204 can use a predetermined string of one or more symbols as the image challenge. However, to maintain a high authentication level, it is preferred to use a new randomly generated image challenge each time an image challenge is presented to a user.

In response to receiving the image challenge, the user enters a corresponding passcode into the user interface. The passcode is an ordered string or sequence of second identifiers that are associated with identification units having a first identifier in the image challenge. The Keystone Server 109 can receive the passcode through the network described in FIG. 1B. A Passcode Comparison Module 205 of the Keystone Server 109 determines if the passcode provided by the user is correct by comparing the passcode to stored information relating to the codebook for that user. Typically, the passcode is “correct” if it includes a corresponding second identifier (e.g., an alphanumeric code) for each first identifier (e.g., an image) contained in the image challenge, there is nothing in the passcode that corresponds to the Keystone identifier, and the sequential order of each second identifier in the passcode is the same as the sequential order of each corresponding first identifier in the image challenge. In such embodiments, the user identifies that the keystone identifier is included in a certain position of the image challenge known to the user (which authenticates the image challenge), but the user does not include a corresponding alphanumeric character for the keystone identifier in the passcode. If the keystone identifier does not appear in the predetermined pattern, the website is not authenticated and the user should not provide any additional information. Further details of the image challenge and the passcode are described in reference to FIGS. 3-6.

The Keystone Server 109 can also contain a Password Module 206. The banking web application 108 can be configured to prompt the user for a password that is preset by the financial institution or chosen by the user previous to the instant authentication process. Different embodiments may require the user to provide a password at different point in the authentication process. For example, a user may be prompted to also provide a password when entering a user identifier, or when entering a passcode. The Password Module 206 compares the password to a previously registered password stored, for example, in the SQL Database 110.

The Keystone Server 109 can also include a Security Question Module 207. During the authentication process, the banking web application 108 can be configured to prompt the user for answers to one or more security questions that were previously selected by the user. The Security Question Module 207 is configured to compare the current answer provided by the user to stored information (e.g., SQL Database 110) comprising answers previously supplied by the user for each security question. The security question and corresponding answers are linked to the user identifier. In some embodiments, the Password Module 206 and the Security Question Module store passwords and answers as HASH values. In some embodiments, the data stored in the Keystone Server modules 201-207 is separated and stored in multiple tables or databases to protect the information stored therein from being compromised by an outside security penetration.

Further details of multi-factor authentication are described in reference to FIGS. 3-6, including particular embodiments of the codebook, the image challenge and the passcode. However, the invention is not limited to the particular embodiments described. Aspects described in detail with respect to one embodiment may also be used in other embodiments. Also, aspects described in two or more embodiments may be combined in a third embodiment.

FIG. 3 is a diagram illustrating one example of a codebook 301 that can be used in the previously described authentication systems. The codebook 301 can be delivered to the user as a “hardcopy” (e.g., paper) or in electronic form. A hardcopy file can be delivered to the user via any suitable delivery mechanism, including mail, a commercial mail service, fax, or courier. An electronic file codebook can be in any format (e.g., a Word document, a PDF, an audio file, a visual file, or an audiovisual file). Codebooks delivered in electronic format can be printed by the user. Electronic codebooks can also be stored on an electronic device, for example, a cell phone, flash memory device, a personal digital assistant, or a computer. In some embodiments, the printed codebook is small enough to be easily folded and placed into a wallet or purse, for example 4 inches by 4 inches. The user can be given the choice of the delivery mechanism and the form of the delivery, or the vendor can choose to decide these options. Typically, the codebook 301 is delivered to the user before the vendor site is accessed. Alternatively, after a user is first registered or after being authenticated, the user can create or be assigned a codebook 301 immediately, and download the new codebook 301.

The codebook 301 can contain a plurality of independent identification units 302. Each identification unit includes a first identifier 303 and a second identifier 304. The first identifier 303 can be any symbol, e.g., a picture, image, or alphanumeric character. The second identifier 304 can also be any symbol, e.g., a picture, image, or alphanumeric character. In this example the first identifier 303 is an image, and the second identifier 304 is an alphanumeric character. In some embodiments, the first and second identifiers 302, 303 are selected by the user from a certain set of predetermined symbols provided by a vendor or the authentication system. Alternatively, the user can provide one of more of the symbols used as identifiers during a codebook generation process.

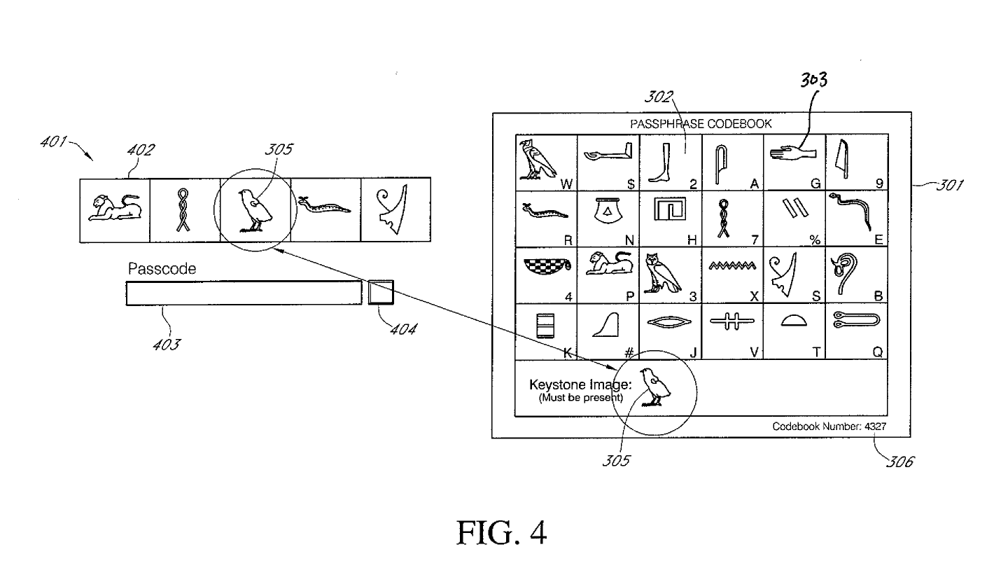

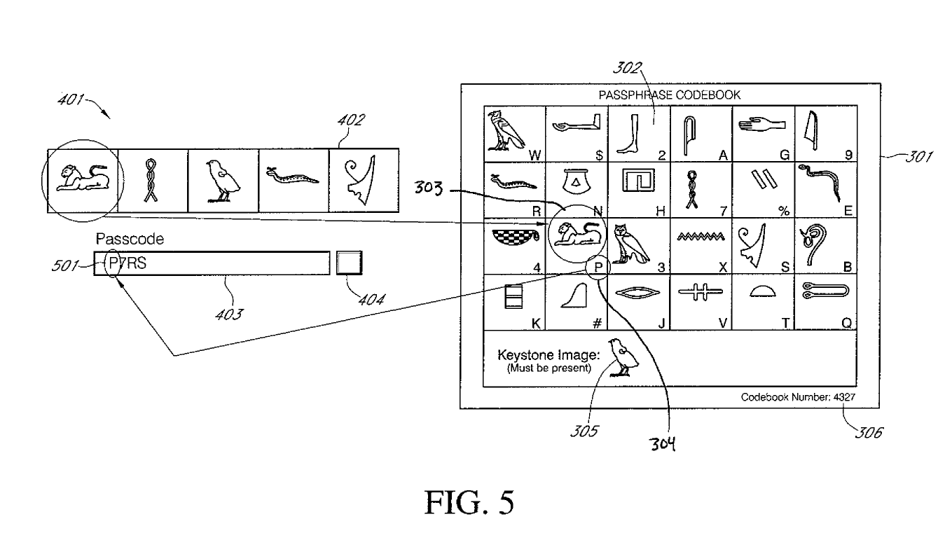

A keystone identifier 305 is also typically included on the codebook 301. The keystone identifier 305 appears in a image challenge in order to authenticate the vendor site to the user, and its use is further described in reference to FIGS. 4 and 5. The keystone identifier can be located (anywhere) on the codebook 301, and can be any symbol, such as a picture, image, or alphanumeric character. The keystone identifier 305 can be selected from a list of symbols provided to the user, or provided by the user. In some embodiments, the keystone identifier is assigned by the vendor or by the authentication system.

A codebook identifier 306 is typically located on the codebook 301. A M-FA system can use the codebook identifier 306 to access specific user information which is used to authenticate the user, generate an image challenge, and evaluate a passcode entered by the user. In some embodiments, the codebook number is not on the codebook, but instead is provided to a user through a separate communication. The codebook identifier 306 is an example of an authentication factor that the user “has” or “knows.” Each codebook identifier 306 corresponds to a certain codebook that has been delivered to a user, and it is associated with the specific codebook information.

A codebook can be invalidated if it is damaged, lost, stolen, or updated with new or different identification units for enhanced security. A new codebook having a new codebook identifier can also be generated and delivered to the user upon invalidation of the old codebook. A new codebook can be generated at the vendor's request, the user's request, or at regularly scheduled intervals (e.g., one month, three months, six months). In some embodiments, the codebook, including some or all of the identification units, the keystone identifier, and the codebook identifier can be in color. In some embodiments, color is used as another authentication factor, or as an aspect of another authentication factor.

FIG. 4 shows an example of an image challenge 401 generated by the vendor site that can be displayed on a user interface of the user's communication device (e.g., client computer 101, FIG. 1B). In this example, the Image Challenge Module 204 generated an image challenge having five positions 402, each position containing a symbol. Four of the positions contain a first identifier 303 from four identification units 302 of the codebook 301. One position of the image challenge (in this example the middle position) contains the keystone identifier 305 of the codebook 305. In other examples, the image challenge 401 contains at least two positions, at least one position displaying a first identifier 303 and at least one position displaying a keystone identifier 305. The Administration Module 201 can allow the vendor to select how many positions 402 to include in each image challenge.

In some embodiments, the number of positions 402 in the image challenge is dynamically determined based upon user requirements and/or the risk level of the operation. For example, the number of positions in the image challenge can be increased for high risk level activities. In some examples, the keystone identifier 305 must appear in a predetermined fixed position in the image challenge. In some embodiments, the user selects the position in which the keystone identifier 305 will be located; in other embodiments the position is selected (e.g., randomly assigned) by the vendor. In some embodiments, the codebook can contain more than one keystone identifier, and the image challenge can contain more than one position reserved for the keystone identifiers. The user authenticates the vendor site by verifying that the keystone identifier 305 is located in the image challenge, and if required in the embodiment, by verifying the keystone identifier 305 is located in the correct predetermined position 402 of the image challenge. In embodiments in which the codebook is in color, the user can further authenticate the vendor site by verifying that the keystone identifier 305 is the correct color.

FIG. 5 illustrates how a user would use a codebook 301 to produce a passcode 501 in response to an image challenge 401. A passcode 501 can be a string of alphanumeric characters entered by the user into the dialog box 403. The user enters a second identifier 304 from the codebook 301 that corresponds to the first identifier 303 in the image challenge 401. In a typical implementation, each second identifier in the passcode must be in the same sequential order as the ordered format of each corresponding first identifier 303 appearing in the image challenge 401. The keystone identifier 305 can be ignored for purposes of entering the passcode 501. One or more characters of the passcode can be case sensitive, requiring the user to know that it is a case sensitive value. The choice of using case sensitive passcode characters parameter can be set using the Administration Module 201.

In some embodiments, the keystone identifier can be reflected in the passcode by including information in a position corresponding to the keystone identifier position in the image challenge or in another position of the passcode. In one example the user includes a symbol in the passcode that corresponds to the keystone identifier. The symbol can be shown in the codebook, or known to the user and not shown in the codebook. In another example a user provides a password in the position of the keystone identifier; in such embodiments the passcode can have more predetermined positions than the image challenge to accommodate a user personal identification number (PIN) or password, or be of variable length. In another example, a token supplied value can be placed in the passcode in the position corresponding to the keystone identifier. For a higher level of authentication, the keystone identifier can be decoded by a second user who then enters a responsive password or symbol.

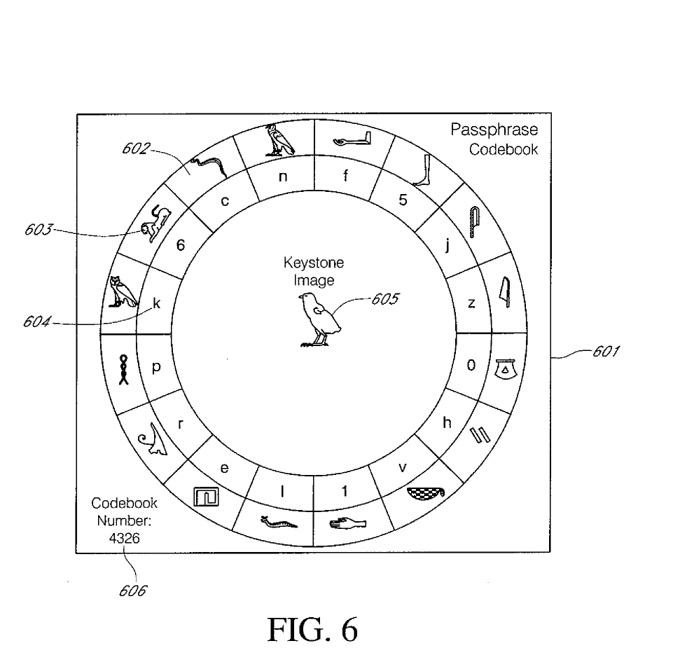

FIG. 6 illustrates another embodiment of a codebook 601. Codebook 601 contains a first identifier 603 and a second identifier 604 in each identification unit 602. In alternate embodiments, some or all of the identification units contain additional symbols or information. The codebook identifier 606 can be located on the codebook, as illustrated here, or provided separately to the user. As illustrated in the embodiments of FIGS. 3 and 6, a codebook can represent the first and second identifiers of an identification unit in various ways. For example, in FIG. 3 the codebook contains 24 identification units 302 formed in a grid comprised of four rows and six columns, with the keystone identifier 305 placed below. The codebook 601 in FIG. 6 contains 16 identification units 602 formed in a circular pattern with the keystone identifier 605 placed in the center. In other embodiments, more or less identification units can be formed in different configurations with the keystone identifier in a different location with respect to the identification units.

In some embodiments, the user can choose particular identification units or first or second identifiers from a library of symbols provided by the vendor. In other embodiments, the user can provide symbols with which to assemble some or all of the identification units. These symbols can include any visual image amenable to digital rendering, such as photographs, works of art such as paintings or drawings, literature, flags, pennants, colors, or patterns. To enhance security, a codebook can be changed to include different identification units. For example, the codebook can be changed periodically at the request of the user, or as stipulated by the vendor. When a codebook is changed, the new codebook can be provided to the user by downloading, email, facsimile, etc.

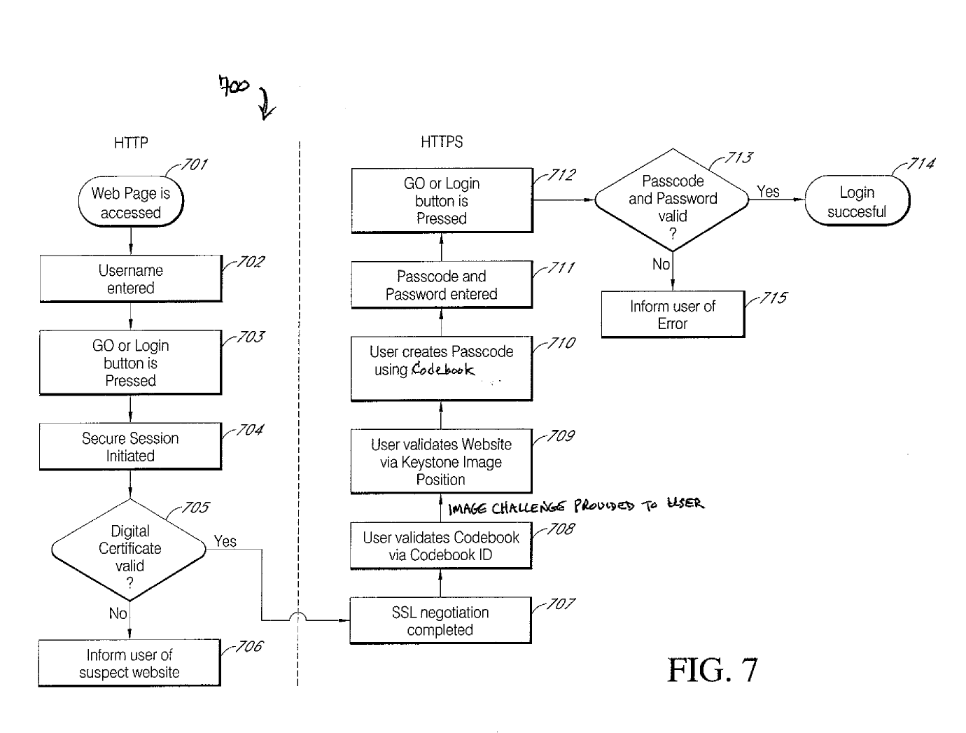

FIGS. 7-10 illustrate an example of a multi-factor authentication process for authenticating a user and a vendor, and examples of data entry fields which a user can enter information as required, according to some embodiments. In particular, FIG. 7 is a flowchart that depicts one example of a process 700 for authenticating a vendor site and authenticating a user accessing the vendor site by authenticating electronic communications between the user and the vendor site. In some embodiments, the process 700 can be performed by the systems illustrated in FIG. 1B. The term “vendor site” refers to an interface to a vendor, and includes websites, automatic teller machines, and direct communication with a vendor's computer system. Some examples of modules that can be used to implement the process 700 are illustrated in FIG. 2, and referenced in the description of FIGS. 7-10.

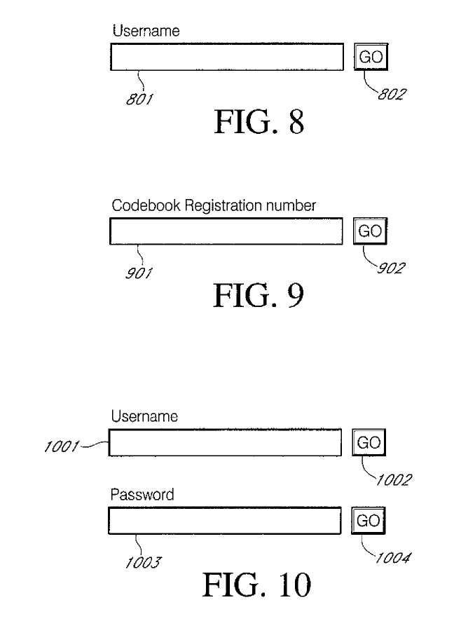

First, at step 701 the user accesses the vendor site from a client device or computer (e.g., client computer 101 of FIG. 1B) configured to communicate over a network that provides access to the desired vendor site. The vendor site queries the user for a user identifier (e.g., a username) by displaying a dialog box 801 (FIG. 8). In step 702 the user enters a user identifier in the dialog box 801 and submits the information to the vendor, e.g., by pressing a “login” or “GO” button in step 703. In this embodiment, the user is initially queried only for a user identifier in order to confirm the authenticity of the vendor site to the user prior to entry of the user's password. The user identifier can be any name pre-registered by the user with the particular vendor.

After submission of the user identifier, at step 704 a Secure Socket Layer (“SSL”) session can be initiated. SSL is a protocol that encrypts a single TCP session. Using this asymmetric encryption, all data exchanged over a TCP socket can be cryptographically protected. SSL is the base of HTTPS—the secure World-Wide Web protocol. In step 705 the vendor can provide information to validate the vendor site (e.g., a public key certificate, an identity certificate, or a digital certificate). If the client device determines the certificate is not valid, the process moves to step 706 and the client device notifies the user that the vendor site may be fraudulent. If the certificate is found to be valid, the process moves to step 707 where the SSL negotiation is completed and the secure session proceeds. The SSL session can be conducted using any suitable electronic secure communication channel. In another embodiment, a third party hosts a website that receives the username (or username and password) of the user and establishes a secure communication channel. In some embodiments, the username and/or password can be entered into a designated username field 1001 and a password field 1003 (FIG. 10), and then submitted to the vendor site using corresponding submission buttons 1002, 1004, prior to initiating an SSL session. In some embodiments, other forms of verification can be used to authenticate the user in lieu of or in addition to the username and password.

Referring again to FIG. 7, after the SSL negotiation is successfully completed, the process 700 continues at step 708 where the vendor site prompts the user to enter a codebook identifier. The codebook identifier can be entered into a user interface, such as the dialog box 901 (FIG. 9). Here, the codebook identifier is used for user validation. Other types of user validation information can also be provided to the authentication system, along with or instead of the codebook identifier. In one example, the user provides an answer to a predetermined security question. Such user information can be used by the authentication process 700 to further validate the user.

In another example, a software token residing on the particular device (e.g., computing device 111, FIG. 1) being used by the user provides the user identification information. The software token can be stored on one or more of the computing devices used by the user to access the vendor. The software token can contain information that would enable the user to skip the step of entering in a codebook identifier or answering security questions after entering in the username. The software token can be stored to the computing device currently being used when either of the two events occur: a new codebook is successfully created, or a user logs in successfully from a certain computing device for the first time. Anytime the user creates a new codebook or performs a codebook reset, then all computers other than the one in which the codebook was created on would have an invalid software token. In some embodiments, two or more types of user validation information are provided. Upon validation, the authentication system proceeds to identify the codebook information that corresponds to the user.

The Codebook Identifier Module 203 (FIG. 2) can evaluate the authenticity of a submitted codebook identifier or other types of user validation information. If the codebook identification or user validation information is incorrect, the vendor site can display an appropriate error message to the user or provide other status messages to the user and may prompt the user to enter valid information. The vendor site will not allow the user to continue the login process until the user provides valid user identification information.

If the codebook has been invalidated and replaced with a new codebook, the vendor site can notify the user of this occurence and display a message prompting the user to enter the new codebook identifier. If the old codebook was invalidated but a new codebook has not been generated and delivered to the user, the vendor site can instruct the user to generate a new codebook.

During any point in the login process, the vendor site can display an option allowing the user to report a lost or stolen codebook. For example, the vendor site can display a button states “I lost my codebook.” When selected, the current codebook is invalidated and a new codebook must be generated before access is allowed. As another option, the vendor site can produce a display after the user submits a user identifier inquiring if the codebook has been lost or stolen, to which the user is required to respond before entering the codebook identifier, and the response could include providing user identification information. If the user reports that the codebook has been lost or stolen, the vendor site can direct the user to a webpage designed to create a new codebook or automatically assign a new codebook to the user. Upon creation of the new codebook the old codebook is invalidated.

In another option, at any time during the login process the user can create a new codebook, or reset the existing codebook. Resetting the existing codebook can result in a software token being downloaded to the client computer being used by the user. Upon resetting the codebook, software tokens that were previously downloaded to any other computer immediately become invalid.

The vendor site can verify the user's identity before allowing the new codebook to be created, for example by displaying one or more questions to verify the user's identity. If the questions are answered correctly, the vendor site invalidates the old codebook and directs the user to a webpage designed to create a new codebook or assigns a new codebook. In another example, the vendor site can verify the user's identity by sending a temporary passcode to the user (e.g., via email) and invalidate the old codebook. If the user enters the correct temporary passcode into the vendor site, the user can then be directed to a webpage designed to create a new codebook or can be automatically assigned a new codebook.

In some embodiments, if the user has previously successfully accessed the vendor site with the same codebook that is currently valid and from a computer “known” to the M-FA system, the process 700 can to skip the step of entering the codebook identifier. However, this may provide a lower level of authentication. In this case, the M-FA system uses codebook authentication information that is associated with the user identifier and/or information provided by a software token on the known computer. If the old codebook has been invalidated since the last successful access by the user, the vendor site can generate an error message or prompt the user for the new codebook number after the username has been entered.

Referring again to FIG. 7, if process 700 determines the codebook identifier is valid the process 700 creates a image challenge 401 using information associated with the user's codebook. The Image Challenge Module 204 (FIG. 2) can perform this step. Process 700 then displays the image challenge to the user and prompts for the user response at step 709. An example of an image challenge is shown at 401 in FIG. 4. To generate the image challenge, the process 700 selects one or more identification units that appear on the user's codebook 301 and determines a sequential order for a representation of each first identifier of each of the selected one or more identification units. Typically, the Image challenge Module 204 also determines what position the keystone identifier should occupy in the image challenge based on predetermined information, so that the resulting image challenge includes the keystone identifier in a position expected by the user. In some embodiments, e.g., those requiring a lower level of authentication, the keystone identifier can be placed anywhere in the image challenge. The Image Challenge Module 204 assembles the first identifiers and the keystone identifier based on the determined sequential order. In some embodiments, the image challenge is downloaded as a separate file and is not saved in the temporary files on the client computer. In some embodiments, the image challenge is overwritten with other data subsequent to its display so it exists only when it is being displayed and cannot be ascertained later. The page on the vendor site that displays the image challenge can include hidden variables to determine the maximum duration of the login/authentication. In some embodiments, the length of time the user has to provide a passcode responsive to the image challenge can also be limited by the M-FA system.

The user verifies the authenticity of the vendor site at step 709 of FIG. 7 by confirming that the keystone identifier 305 is present in the image challenge and is located in the correct position, and that each first identifier in the image challenge corresponds to an identification unit in the user's codebook. In the example shown in FIGS. 4 and 5, the keystone identifier 305 is located in the third position from the left. If the keystone identifier is displayed correctly, the user proceeds to determine a passcode from the codebook at step 710. At step 711, the user enters the passcode into the user interface of the client computer. At step 712 the user submits the passcode for validation. The user interface 112 can be configured with a control button (e.g., “GO” button 404) configured to submit the passcode for validation.

Process 700 evaluates the passcode entered by the user at step 711. The Passcode Comparison Module 205 can perform this evaluation. If the passcode is incorrect, the process and the vendor site displays an error message or other notification to the user at step 715. The vendor site can display the same image challenge or a different image challenge to the user after entry of an incorrect passcode. In some embodiments, only a certain number of incorrect passcode entries are allowed.

Also at step 711 the vendor site can query the user for a password. The process 700 can display a dialog box or other means to enter the password. This query can occur anytime after the SSL negotiation is initiated, and is typically done after SSL negotiation is completed. For example, the vendor site can require a user to provide a password at the same time as the image challenge at step 711, or after the passcode has been determined to be valid. The vendor site can use other forms of verification in lieu of, or in addition to, a password. Predetermined security questions can be used for verification of the user. When the vendor site uses such embodiments, the Password Evaluation Module 206 and/or Security Question Evaluation Module 207 can verify the password or the user's answer to the security question. The multi-factor authentication methods described herein can also be employed in conjunction with other security measures or identity determination processes, such as requiring a smart card, USB token, one or more biometric factors, bibliographic information, or a software token. The methods described herein for M-FA can also be combined with any other authentication technology known by those in the relevant art.

The multi-factor authentication system can implement various levels of authentication. The levels can be set by the vendor, dynamically determined by the vendor or authentication system based on login information or information received from another source. For example, authentication levels can be determined based on login and/or session information, which can include but is not limited to the user's IP address or geographic location, the time of day, the date and/or time of the last login, and/or a change in activity level of the account. Authentication levels can also be determined by other information, including a determined threat environment as provided to the M-FA system, or determined by the M-FA system based on, for example, failed access attempts.

In some embodiments, the vendor can determine the authentication level required to perform certain actions or to perform actions at a certain time. For example, the number of positions in the image challenge may be increased when a higher authentication level is desired. The authentication level can also vary based on the particular transactions between the vendor and the user. For example, the vendor can first provide an image validation (which requires a user to verify the images using his codebook). Then, the vendor can require the user to provide a passcode in response to an image challenge before allowing the user to conduct a particular action. Login processes can incorporate multi-level M-FA to allow access to various types of actions.

Aspects of the multi-factor authentication systems and methods described herein can be used for other electronic communication implementations. For example, M-FA can be applied to email to authenticate the sender. For such an application, a vendor can provide the names of recipients of a mass emailing to a M-FA system which identifies recipients that have implemented M-FA. For the identified recipients, the M-FA system can provide the vendor an image challenge to embed in the email. Accordingly, a combination of one or more identifiers and/or the keystone identifier from a user's codebook could appear in every email sent by a vendor for the identified recipients. Upon receipt of the email, and before accessing any link or attachment in the email, the user can verify the authenticity of the email by confirming that the symbols in the email correspond to an identification unit or keystone in the vendor provided codebook. This development can also be implemented in certified E-mail and information pushing applications.

In some embodiments, a M-FA process can be used when a user attempts to access an account with the vendor through an automated teller machine (ATM). Fraudulent schemes have surfaced involving ATMs, such as fake machines that confiscate or copy an ATM card and record the user's pin number. In order to combat such activities, a vendor can query a user wishing to access an account through an ATM for a username or other identification information before requiring the user to insert an ATM card or enter a pin number. After receiving a username, the ATM can display a image challenge. The user can then verify the authenticity of the ATM by confirming the presence and correct location of the keystone identifier and the presence of appropriate first identifiers in the image challenge. Then, the user can be required to enter a passcode responsive to the image challenge before the user can access the desired account. In some embodiments, a user first provides a “smartcard” or other physical token to the ATM to provide the user's identification. The ATM validates the information on the smartcard, and uses the information to retrieve the user's unique keystone image and first identifiers from the user's codebook. The user can then be required to enter a pin number, a passcode corresponding to the first identifiers, and/or a password to gain access to the ATM for financial transactions.

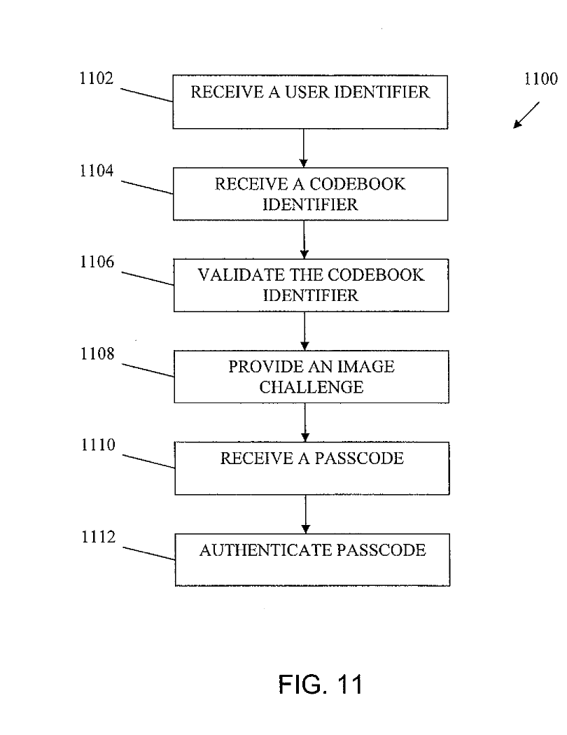

FIGS. 11-14 illustrate flowcharts for various processes used for authenticating a user and/or a vendor system. The systems 100 and 120 illustrated in FIGS. 1A and 1B, respectively, can perform the processes illustrated in FIGS. 11-14. Also, the flowchart illustrated in FIG. 7 can include the steps illustrated in FIGS. 11-14, in whole or in part.

FIG. 11 illustrates an example of a process 1100 of authenticating electronic communication. In this example, the communication is between a user operated client device and a vendor. At step 1102 the process 1100 receives a user identifier from a client device. The identifier can be any indicia identifying the user. The identifier can be input by the user into the client device and then sent to the vendor, or the identifier can be provided by a software token on the client device. At step 1104 the process 1100 receives a codebook identifier from said client device that identifies a codebook in the possession of the user. The user codebook includes a plurality of identification units, each identification unit having a first identifier and a corresponding second identifier and a keystone identifier. At step 1106 the process 1100 validates the codebook identifier by determining whether said codebook identifier is associated with said user identifier. Upon successful validation of the codebook identifier, at step 1108 the process 1100 provides an image challenge to the client device and the image challenge is displayed to the user. The image challenge includes a keystone identifier located in a predetermined position of said image challenge and at least one first identifier, although typically a plurality of first identifiers, arranged in a sequential order. Process 1100 continues to step 1110 where it receives a passcode responsive to said image challenge from the client device. Typically the passcode is input into a user interface on the client device, and then the passcode is sent to an authentication system. At step 1112, the process 1100 authenticates the passcode, and accordingly the user, by determining if the passcode comprises a second identifier corresponding to each first identifier in said image challenge. Authenticating the passcode can also include determining whether each second identifier in said passcode are in the same sequential order as each corresponding first identifier in said image challenge.

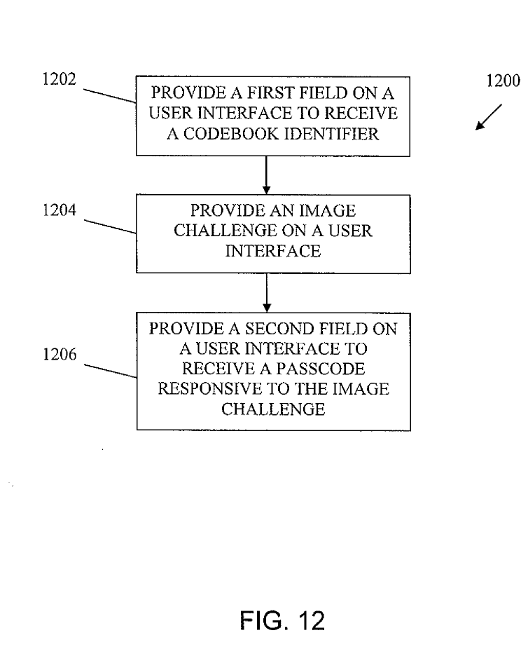

FIG. 12 illustrates a process 1200 of authenticating electronic communication of a user who has established a communication channel with an electronically accessible vendor. At step 1202 process 1200 provides a first field displayable on a user interface. The first field is configured to receive a codebook identifier, where the codebook identifier identifies the most recent codebook possessed by the user. The codebook includes a plurality of identification units, each identification unit having a first identifier and a corresponding second identifier, and a keystone identifier. At step 1204, process 1200 provides an image challenge that is displayable on said user interface. The image challenge includes a keystone identifier and at least one first identifier of an identification unit from a codebook associated with said codebook identifier. The keystone identifier can be located in the image challenge at a predetermined position known only to the user and an authentication system. The process 1200 also provides, at step 1206, a second field displayable on said user interface, where the second field is configured to receive a passcode responsive to the image challenge. The valid passcode includes a second identifier corresponding to each first identifier in said image challenge, and the position of each second identifier in said passcode is in the same sequential order as each corresponding first identifier in said image challenge. Authentication of the communication is based on whether the user provided a valid passcode.

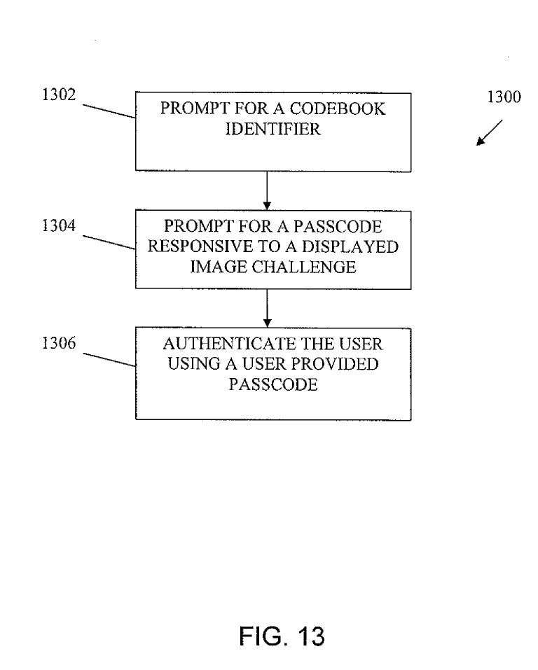

FIG. 13 illustrates a process 1300 of authenticating electronic communication between a vendor site and a user. At step 1302 process 1300 prompts the user for a codebook identifier. The codebook identifier is associated with the user's codebook and includes a plurality of independent identification units, wherein each identification unit comprises a first identifier and a second identifier, and a keystone identifier. Typically the codebook identifier is printed on the codebook, but in some embodiments it is provided to the user separately from the codebook. Following receipt of the codebook identifier, at step 1304 the process 1300 prompts the user for a passcode in response to an image challenge displayed to the user. Upon receipt of a passcode, at step 1306 the process 1300 authenticates the user by determining if the passcode is valid. For example, whether the passcode comprises a corresponding second identifier of an identification unit for each first identifier of the identification unit(s) displayed in the image challenge. Also, in some embodiments, authentication based on the passcode determines if the passcode contains other authentication information, for example, a password or some other user entered or software token provided information associated with the user.

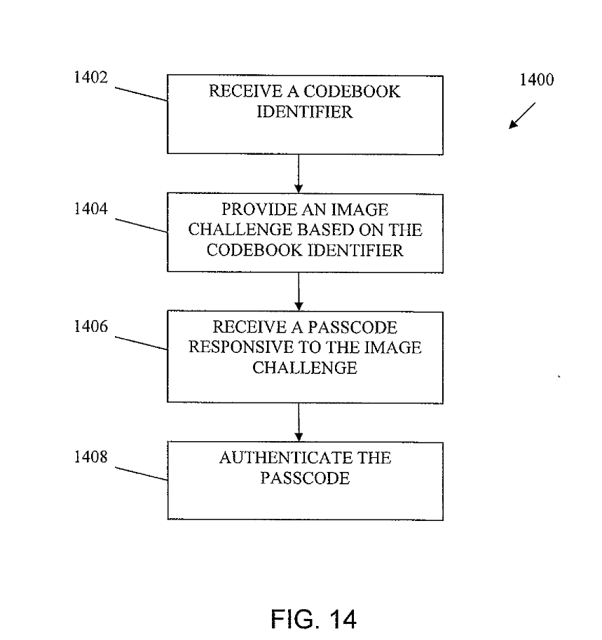

FIG. 14 illustrates a process 1400 of authenticating electronic communication between a user operated client device and a vendor. In step 1402, process 1400 receives a codebook identifier from the client device that identifies a codebook. At step 1404, process 1400 provides an image challenge based on said codebook identifier, the image challenge including a keystone identifier and at least two first identifiers in a sequential order. The keystone identifier is located in a predetermined position of said sequential order, and said at least two first identifiers are located in a random order in said sequential order. At step 1406 the process 1400 receives a passcode responsive to said image challenge from said client device. At step 1408, process 1400 authenticates the passcode by determining if said passcode includes a second identifier corresponding to each first identifier in the image challenge.

The methods of this development implemented via one or more computers configured to execute one or more computer program embodying the desired method. The computer programs can be provided as computer program products comprising a computer useable medium having computer program logic recorded thereon, which when executed by a computer processor configured to execute the same, performs an authentication method according to the invention. The computer program logic can comprise computer program code logic configured to perform a series of operations required to implement the particular embodiment desired. Computer usable medium refers to any medium or device that can be used to provide software or program instructions to a computer or computer system, and includes media such as removable data storage devices. The computer usable medium also includes a machine readable medium comprising instructions for performing an authentication method according to the invention that upon execution causes a machine to execute the authentication method. As those in the art will appreciate, the embodiments, features, and functionality of the development as described are not dependent on particular computer system or processor architecture or on a particular operating system. The development can also be implemented using other computer or processor systems and/or architectures.

Computer programs or computer control logic can be stored in a memory in communication with the processor(s) intended to execute the program or can be received via any suitable communications interface. Computer programs executed according to the invention can enable the computer system to perform the desired functions. In embodiments where the methods of the development are implemented using software, the software can be stored in, or transmitted via, a computer program product and loaded into a computer system using any suitable approach, including a removable storage device, hard drive, or communications interface. When the control logic or software is executed by the processor(s), the processor(s) are caused to perform the functions of the invention. In other embodiments, the invention is implemented primarily in hardware using, for example, hardware components such as PALs, application specific integrated circuits (ASICs), or other hardware components. Implementation of a hardware state machine so as to perform the functions described herein will be apparent to persons skilled in the relevant art(s). In another embodiment, elements are implemented using a combination of both hardware and software.

The development illustratively described herein suitably may be practiced in the absence of any element(s) not specifically disclosed herein. The terms and expressions which have been employed are used as terms of description and not of limitation, and there is no intention that in the use of such terms and expressions of excluding any equivalents of the features shown and described or portions thereof, but it is recognized that various modifications are possible within the scope of the invention claimed. Thus, it should be understood that although the development has been specifically disclosed by certain embodiments and optional features, modification and variation of the concepts herein disclosed may be resorted to by those skilled in the art, and that such modifications and variations are considered to be within the scope of this invention as defined by the appended claims.

What is claimed is:

1. A method of authenticating electronic communication between a user operated client device and a vendor, the method comprising:
receiving a user identifier from a client device;
receiving a codebook identifier from said client device that identifies a codebook, said codebook comprising
a plurality of identification units, each identification unit having a first identifier and a corresponding second identifier; and
a keystone identifier;
validating the codebook identifier by determining whether said codebook identifier is associated with said user identifier;
upon successful validation of the codebook identifier, providing an image challenge comprising said keystone identifier located in a predetermined position of said image challenge and at least one first identifier arranged in a sequential order;
receiving a passcode responsive to said image challenge from the client device; and
authenticating said passcode by determining if said passcode comprises a second identifier corresponding to each first identifier in said image challenge.

2. The method of claim 1, wherein said authenticating further comprises determining whether each second identifier in said passcode are in the same sequential order as each corresponding first identifier in said image challenge.

3. The method of claim 1, wherein said first identifier comprise an image.

4. The method of claim 1, wherein said second identifier comprises an alphanumeric character.

5. The method of claim 1, wherein said image challenge comprises at least three first identifiers.

6. The method of claim 1, wherein the position of said keystone identifier in said image challenge is predetermined by an authentication system.

7. The method of claim 1, wherein said providing said image challenge comprises:
selecting at least one identification unit from said plurality of identification units; and
assembling the first identifier of each selected identification unit and said keystone identifier into said image challenge.

8. The method of claim 1, wherein said image challenge comprises at least two first identifiers, and wherein said providing said image challenge further comprises determining a random order for said at least two first identifiers in said image challenge.

9. The method of claim 1, further comprising:
determining whether said user identifier matches a known user identifier; and
initiating a secure communication channel between said client device and said vendor if the user identifier matches a known user identifier.

10. The method of claim 9, wherein initiating a secure communication channel comprises providing vendor information to said client device to authenticate said vendor.

11. The method of claim 10, wherein said vendor information comprises a digital certificate identifying said vendor.

12. The method of claim 1, further comprising:
receiving user identity information from said client device; and
determining whether to allow access to said vendor based on said identity information and said passcode.

13. The method of claim 12, wherein said user identity information is selected from the group consisting of a password, biometric data, and bibliographic information.

14. The method of claim 1, wherein said user identifier comprises a username.

15. The method of claim 1, wherein said user identifier comprises information provided by a software token on said client device.

16. A method of authenticating an electronic communication of a user who has established a communication channel with an electronically accessible vendor, comprising:
providing a first field displayable on a user interface, said first field configured to receive a codebook identifier, said codebook identifier being associated with a codebook comprising a plurality of identification units, each identification unit having a first identifier and a corresponding second identifier, and a keystone identifier;
providing an image challenge displayable on said user interface, said image challenge comprising a keystone identifier and at least one first identifier of an identification unit from a codebook associated with said codebook identifier;
providing a second field displayable on said user interface, said second field configured to receive a valid passcode responsive to said image challenge, said passcode comprising at least one second identifier, each said at least one second identifier corresponding to one first identifier in said image challenge, each second identifier in said passcode being in the same sequential order as each corresponding first identifier in said image challenge.

17. The method of claim 16, wherein said first identifier comprise an image, and wherein said second identifier comprises an alphanumeric character.

18. The method of claim 16, wherein keystone identifier position in said image challenge is predetermined.

19. A method of authenticating communication between an electronically accessible vendor site and a user, the method comprising:
prompting for a codebook identifier from a user, said codebook identifier associated with a codebook comprising
a plurality of independent identification units, wherein each identification unit comprises a first identifier and a second identifier, and
a keystone identifier;
following receipt of said codebook identifier, prompting for a passcode in response to an image challenge displayed to said user, said image challenge comprising said keystone identifier and a first identifier for at least one identification unit in said codebook; and
upon receipt of said passcode, authenticating the user by determining if said passcode comprises a corresponding second identifier of an identification unit for each first identifier of said identification unit displayed in said image challenge.

20. The method of claim 19, wherein said authenticating further comprises determining if said corresponding second identifier in said passcode is in the same sequential order as said each first identifier in said image challenge.

21. The method of claim 19, further comprising prompting for a user identifier, and authenticating the user using the user identifier and the codebook identifier.

22. The method of claim 20, wherein the user identifier comprises at least one of a user name, a password, and a software token.

23. The method of claim 19, wherein the user connection is made via an automated teller machine (ATM).

24. The method of claim 19, wherein the user connection is made via a wide area network having a user side and a vendor side, wherein said user side comprises a user computing device configured for electronic communication over said network, and wherein said vendor site comprises a vendor computing device configured for electronic communication over said network.

25. The method of claim 24, wherein the vendor site comprises a website.

26. The method of claim 19, wherein said first identifier comprises an image, and wherein said second identifier comprises an alphanumeric character.

27. A method of authenticating electronic communication between a user operated client device and a vendor, the method comprising:
receiving a codebook identifier from said client device that identifies a codebook, said codebook comprising a plurality of identification units, each identification unit having a first identifier and a corresponding second identifier, and a keystone identifier;
providing an image challenge based on said codebook identifier, said image challenge comprising said keystone identifier and at least two first identifiers in a sequential order, said keystone identifier being located in a predetermined position of said sequential order, and said at least two first identifiers being located in a random order in said sequential order;
receiving a passcode responsive to said image challenge from said client device; and
authenticating said passcode by determining if said passcode comprises a second identifier corresponding to each first identifier in the image challenge.

28. A machine readable medium comprising instructions for authenticating an electronic communication between a user operated client device and a vendor computer system that upon execution cause a machine to:
receive a codebook identifier from said client device that identifies a codebook, said codebook comprising a plurality of identification units, each identification unit having a first identifier and a corresponding second identifier; and a keystone identifier;
provide an image challenge comprising said keystone identifier and at least two first identifiers in a sequential order, said keystone identifier being located in a predetermined position of said sequential order, and said at least two first identifiers being located in a random order in said sequential order;
receive a passcode responsive to said image challenge from the client device; and
authenticate said passcode by determining if said passcode comprises a second identifier corresponding to each first identifier in the image challenge, each second identifier in said passcode being in the same sequential order as each corresponding first identifier in said image challenge.

29. A method of authenticating an electronic communication between a client device operated by a user and a vendor computer system, comprising:
means for receiving a codebook identifier from said client device that identifies a codebook, said codebook comprising a plurality of identification units, each identification unit having a first identifier and a corresponding second identifier; and a keystone identifier;
means for providing an image challenge comprising said keystone identifier and at least two first identifiers in a sequential order, said keystone identifier being located in a predetermined position of said sequential order, and said at least two first identifiers being located in a random order in said sequential order;
means for receiving a passcode responsive to said image challenge from the client device; and
means for authenticating said passcode by determining if said passcode comprises a second identifier corresponding to each first identifier in the image challenge, each second identifier in said passcode being in the same sequential order as each corresponding first identifier in said image challenge.

30. A system for authenticating an electronic communication, comprising:
a user identifier module configured to receive a user identifier and determine if said user identifier is associated with a known user;
a codebook identifier module configured to receive a codebook identifier and validate said codebook identifier by determining whether said codebook identifier is associated with said user identifier and associated with a codebook, said codebook comprising a plurality of identification units, each identification unit having a first identifier and a corresponding second identifier, and a keystone identifier;
an image challenge module configured to provide an image challenge upon successful validation of the codebook identifier, said image challenge comprising said keystone identifier located in a predetermined position of said image challenge and a plurality of first identifiers arranged in a sequential order;
a passcode comparison module configured to authenticate said passcode by determining whether said passcode comprises a corresponding second identifier of an identification unit for each first identifier of said identification unit in said image challenge, and whether said corresponding second identifier in said passcode is in the same sequential order as each first identifier in said image challenge.

31. The system of claim 30, wherein said first identifier comprises an image, and wherein said second identifier comprises an alphanumeric character.
